(19) United States
(12) Patent Application Publication
(10) Pub. No.: US 2023/0391123 A1
(43) Pub. Date: Dec. 7, 2023

(54) INKJET TEXTILE PRINTING APPARATUS

(71) Applicant: KYOCERA Document Solutions Inc., Osaka (JP)

(72) Inventor: Masahiro HIGASHITANI, Osaka-shi (JP)

(73) Assignee: KYOCERA Document Solutions Inc., Osaka (JP)

(21) Appl. No.: 18/328,589

(22) Filed: Jun. 2, 2023

(30) Foreign Application Priority Data
Jun. 6, 2022 (JP) 2022-091728

(51) Int. Cl. B41M 5/00; D06P 5/30; D06P 5/00; D06P 3/14; D06P 3/30; B41J 3/407

(52) U.S. Cl. CPC B41M 5/0011; D06P 5/30; D06P 5/001; D06P 5/002; D06P 3/14; D06P 3/30; B41M 5/0076; B41J 3/4078; D06P 1/90

(57) ABSTRACT

An inkjet textile printing apparatus that forms an image in an image formation area of a textile printing target includes a pretreatment head that ejects a pretreatment liquid toward the image formation area, a recording head that ejects an inkjet ink toward the image formation area, and a controller that controls a time interval X from ejection of the pretreatment liquid toward the image formation area by the pretreatment head to ejection of the inkjet ink toward the image formation area by the recording head. The controller performs control so that the time interval X when the textile printing target is made of a specific material is shorter than the time interval X when the textile printing target is made of a material other than the specific material. The specific material is a napped material, a wool material, or an animal hair material.

### INCORPORATION BY REFERENCE

The present application claims priority under 35 U.S.C. § 119 to Japanese Patent Application No. 2022-91728, filed on Jun. 6, 2022. The contents of this application are incorporated herein by reference in their entirety.

### BACKGROUND

The present disclosure relates to an inkjet textile printing apparatus.

For example, an inkjet ink containing a pigment and a dispersant is used in an inkjet textile printing apparatus in some cases. The inkjet textile printing apparatus is demanded to be able to form images with excellent color formability while inhibiting occurrence of blotting. To meet the above demand, the inkjet textile printing apparatus may perform pretreatment in advance by ejecting a pretreatment liquid toward a textile printing target. The pretreatment on the textile printing target allows the pigment to be easily fixed to the textile printing target. In one example, an inkjet ink textile printing method is proposed that uses a pretreatment liquid containing resin particles.

### SUMMARY

An inkjet textile printing apparatus according to an aspect of the present disclosure is an inkjet textile printing apparatus that forms an image in an image formation area of a textile printing target, and includes a pretreatment head that ejects a pretreatment liquid toward the image formation area, a recording head that ejects an inkjet ink toward the image formation area, and a controller that controls a time interval X from ejection of the pretreatment liquid toward the image formation area by the pretreatment head to ejection of the inkjet ink toward the image formation area by the recording head. The controller performs control so that the time interval X when the textile printing target is made of a specific material is shorter than the time interval X when the textile printing target is made of a material other than the specific material. The specific material is a napped material, a wool material, or an animal hair material.

### BRIEF DESCRIPTION OF THE DRAWINGS

FIG. 1 is a side view of an example of main elements of an inkjet textile printing apparatus.

FIG. 2 is a diagram illustrating the details of a carriage.

FIG. 3 is a block diagram for controlling the main elements of the inkjet textile printing apparatus illustrated in FIG. 1.

### DETAILED DESCRIPTION

The following describes an embodiment of the present disclosure. In the following, measurement values for volume median diameter (D₅₀) are values as measured using a dynamic light scattering type particle size distribution analyzer (“ZETASIZER (registered Japanese trademark) NANO ZS”, product of Malvern Instruments Ltd.) unless otherwise stated.

In the present specification, the term “(meth)acryl” is used as a generic term for both acryl and methacryl. For each component indicated in the present specification, one type of the component may be used independently, or two or more types of the component may be used in combination.

<Inkjet Textile Printing Apparatus>

The following describes an inkjet textile printing apparatus according to an embodiment of the present disclosure. The inkjet textile printing apparatus according to the present disclosure is an inkjet textile printing apparatus that forms an image in an image formation area of a textile printing target, and includes a pretreatment head that ejects a pretreatment liquid toward the image formation area, a recording head that ejects an inkjet ink (also referred to below simply as ink) toward the image formation area, and a controller that controls a time interval X from ejection of the pretreatment liquid toward the image formation area by the pretreatment head to ejection of the inkjet ink toward the image formation area by the recording head. The controller performs control so that the time interval X when the textile printing target is made of a specific material is shorter than the time interval X when the textile printing target is made of a material other than the specific material. The specific material is a napped material, a wool material, or an animal hair material.

Here, the wool material and the animal hair material refer to a material containing wool and a material containing animal hair, respectively. The wool or the animal hair has a percentage content in the wool material or in the animal hair material of preferably at least 50% by mass, and more preferably at least 80% by mass, for example. The animal hair refers to animal fiber derived from any mammal other than sheep. Examples of the animal hair include goat hairs (e.g., cashmere and mohair), llama hair, vicuna hair, alpaca hair, camel hair, rabbit hairs (e.g., angora), and horse hair. The napped material refers to a material subjected to napping. Examples of the napped material include thick woolen fabric and flannel. A napping method is for example a method by which a material (fabric or the like) is brought into contact with a rotating roller around which needle cloth or thistle has been wound. Through the above processing, fibers are scratched out of a span yarn on the surface of the material, thereby obtaining a napped material.

The inventor of the present disclosure acquired the knowledge that among various materials of a textile printing target, the specific material tends to cause blotting and impair color formability even when pretreatment is performed. The inventor of the present disclosure then hypothesized that a reason why blotting and impairment of color formability tend to occur on the specific material is that uneven pretreatment occurs on the specific materials.

The reason why uneven pretreatment occurs on a napped material is described. Absorbency of the pretreatment liquid is thought to vary from part to part in the napped material. In detail, when the napped material is subjected to pretreatment, a portion of the pretreatment liquid attached to the tip end of napped fiber remains as it is on the surface of the fiber while the other portion thereof attached to the other part of the napped fiber penetrates into the napped material. As a result, once pretreatment is performed on the napped material, areas of the surface of the fiber where the pretreatment liquid does not remain are present on the surface of the napped material. The above is thought to cause uneven pretreatment on the napped material.

A reason why uneven pretreatment occurs on the wool material and the animal hair material is described. The wool and the animal hair contain a protein called keratin as a main component. The wool and the animal hair are each constituted by a cortical portion (cortex) that forms the core structure of the wool or the animal hair and a scaly epidermal portion (scale) that coats the cortical portion. Of these, the scaly epidermal portion has water-repellent properties. Therefore, when the wool material or the animal hair material is pretreated, the pretreatment liquid is repelled in almost area of the surface of the material while the repelled pretreatment liquid gathers in a local area of the surface of the material to form a droplet. As such, once the pretreatment liquid is performed on the wool material or the animal hair material, areas without the pretreatment liquid and areas with droplets of the pretreatment liquid attached thereto are present on the surface of the material. It is thought that uneven pretreatment occurs on the wool material or the animal hair material as a result. The inventor of the present disclosure acquired the knowledge that in textile printing on the specific material, images with excellent color formability can be formed with occurrence of blotting inhibited through shortening the time interval X from ejection of the pretreatment liquid to ejection of the ink as compared to the case of textile printing on other materials. This is because shortening of the time interval X can achieve ink ejection before uneven pretreatment occurs on the specific material to reduce the influence of uneven pretreatment. The inkjet textile printing apparatus of the present disclosure is based on the above knowledge. The inkjet textile printing apparatus of the present disclosure performs control, using the controller, so that the time interval X when the textile printing target is made of the specific material is shorter than the time interval X when the textile printing target is made of a material other than the specific material. As a result, the inkjet textile printing apparatus of the present disclosure can inhibit impairment of color formability and occurrence of blotting resulting from uneven pretreatment in textile printing on the specific material. Furthermore, the inkjet textile printing apparatus of the present disclosure can form images with excellent color formability while inhibiting occurrence of blotting through pretreatment being performed even in a case in which any other material is used.

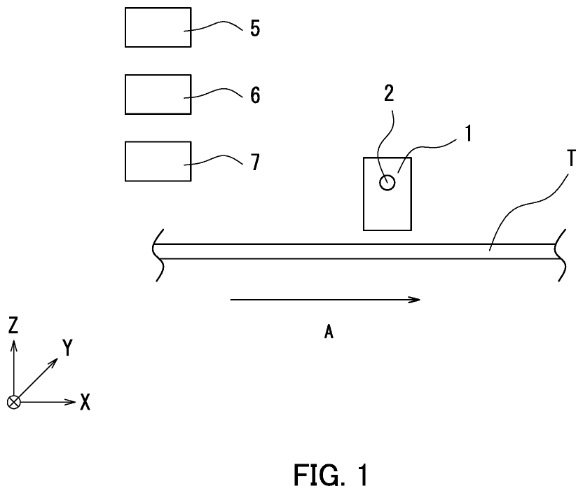

The inkjet textile printing apparatus of the present disclosure is described further in detail next with reference to the accompanying drawings. FIG. 1 illustrates an example of main elements of the inkjet textile printing apparatus of the present disclosure. The inkjet textile printing apparatus of which main elements are illustrated in FIG. 1 is a serial-type inkjet textile printing apparatus. The inkjet textile printing apparatus in FIG. 1 basically includes a carriage 1 disposed above a textile printing target T, a shaft 2 that holds the carriage 1, a controller 5, an input section 6, and storage 7. An X axis indicates an axis in the sub-scanning direction. A Y axis indicates an axis in the main scanning direction. A Z axis indicates an axis in the vertical direction. The textile printing target T is conveyed in a conveyance direction A.

[Carriage]

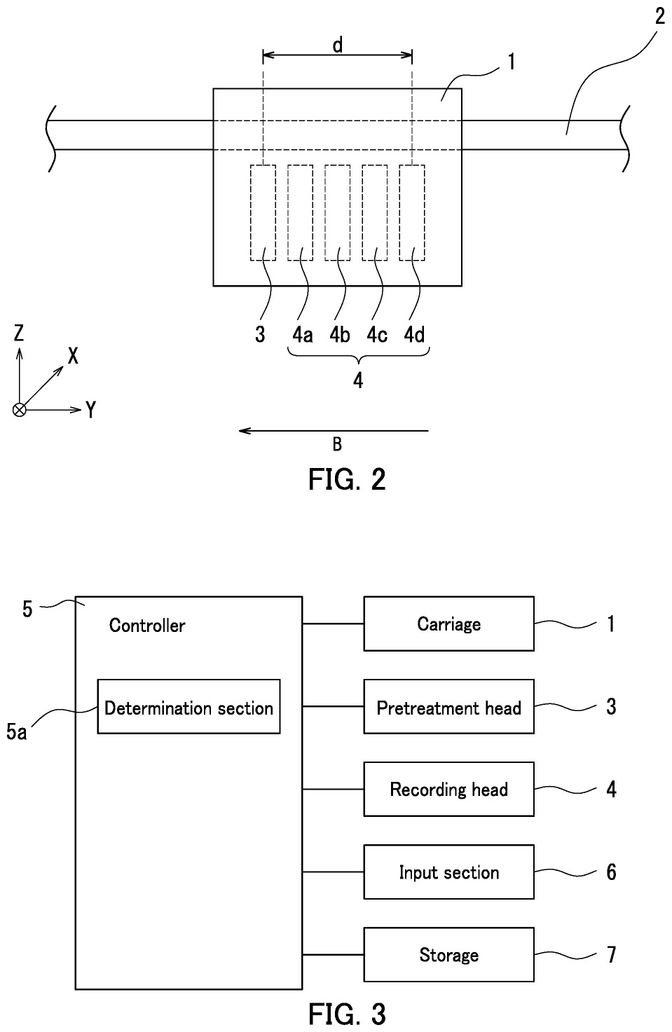

FIG. 2 illustrates the details of the carriage 1. The carriage 1 is held by the shaft 2. The carriage 1 moves back and forth in a Y-axis direction along the shaft 2.

The carriage 1 includes a pretreatment head 3 that ejects the pretreatment liquid toward the textile printing target T and four recording heads 4 that each eject the ink toward the textile printing target T. The carriage 1 performs pretreatment and image formation on an image formation area of the textile printing target T while moving in a scanning direction B at a specific scanning speed. In detail, when the pretreatment head 3 reaches, as a result of the carriage 1 moving in the scanning direction B, directly above a location (image formation area) in the textile printing target T where pretreatment is necessary, the pretreatment head 3 ejects the pretreatment liquid toward the textile printing target T. As a result, the pretreatment liquid is attached to the textile printing target T. In the manner described above, pretreatment is performed. Likewise, when the recording heads 4 reach, as a result of the carriage 1 moving in the scanning direction B, directly above a location in the textile printing target T where ink ejection is necessary, the recording heads 4 each eject the ink toward the textile printing target T. As a result, the ink is attached to the textile printing target T. In the manner described above, image formation is performed. The carriage 1 performs the above series of operations until the carriage 1 reaches one end (left end in FIG. 2) of the ends of the shaft 2. Next, the carriage 1 having reached the one end of the shaft 2 moves in a direction opposite to the scanning direction B until the carriage 1 reaches the other end of the shaft 2. In association therewith, the inkjet textile printing apparatus conveys the textile printing target T in the conveyance direction A. Next, the carriage 1 again performs the pretreatment and the image formation while moving in the scanning direction B. As a result of performing the series of operations as above repeatedly, the inkjet textile printing apparatus forms an image in the image formation area of the textile printing target T.

Description is made below focusing on a specific one point of the textile printing target T in pretreatment and image formation as above. The pretreatment liquid ejected from the pretreatment head 3 attaches to the specific one point, and then each ink ejected from the recording heads 4 attaches to the specific one point after a specific time difference (time interval X). The time interval X is equal to a time period from the time when the pretreatment head 3 reaches directly above the specific one point to the time when the recording heads 4 reach directly above the specific one point. That is, the time interval X is determined according to a head width d and the moving speed (scanning speed) of the carriage 1 (time interval X =head width d/scanning speed). Typically, the scanning speed of the carriage 1 is constant during image formation. Also, the head width d is typically constant. Therefore, the time interval X is the same over the whole area of the textile printing target T.

Here, the head width d refers to a distance in planer view between the center of an opening (orifice) of the pretreatment head 3 from which the pretreatment liquid is to be ejected and the center of an opening of one recording head 4 (a fourth recording head 4d located at the end of the four recording heads 4 in the scanning direction B in FIG. 2) of the four recording heads 4 that is to eject the ink the last.

The head width d is preferably at least 5 mm and no greater than 100 mm, and more preferably at least 15 mm and no greater than 40 mm. The scanning speed is preferably at least 500 mm/sec and no greater than 1500 mm/sec, and more preferably at least 1000 mm/sec and no greater than 1300 mm/sec. The time interval X when the textile printing target T is made of the specific material is preferably at least 5 ms and no greater than 50 ms, and more preferably at least 10 ms and no greater than 30 ms. A ratio ((β/α) of the time interval X (also represented by β) when the textile printing target T is made of a material other than the specific material to the time interval X (also represented by α) when the textile printing target T is made of the specific material is preferably at least 1.1 times and no greater than 4.0 times, and more preferably at least 1.3 times and no greater than 2.0 times.

[Pretreatment Head]

The pretreatment head 3 is a head that ejects the pretreatment liquid. The pretreatment liquid is supplied to the pretreatment head 3. The type of the pretreatment head 3 is not particularly limited, and examples thereof include a piezoelectric head and a thermal inkjet head.

[Recording Heads]

The recording heads 4 include a first recording head 4a, a second recording head 4b, a third recording head 4c, and a fourth recording head 4d. In one example, the first recording head 4a, the second recording head 4b, the third recording head 4c, and the fourth recording head 4d are respectively a recording head for magenta that ejects a magenta ink, a recording head for cyan that ejects a cyan ink, a recording head for yellow that ejects a yellow ink, and a recording head for black that ejects a black ink. The type of the recording heads 4 is not particularly limited, and examples thereof include a piezoelectric head and a thermal inkjet head.

[Controller]

The controller 5 is constituted by a processor. An example of the processor is a central processing unit (CPU). The controller 5 executes a control program to control operation of each element (particularly, the carriage 1, the pretreatment head 3, and the recording heads 4) of the inkjet textile printing apparatus. The controller 5 further includes an integrated circuit for image formation. The integrated circuit for image formation is constituted by an application specific integrated circuit (ASIC), for example. The controller 5 causes each element of the inkjet textile printing apparatus to operate to perform inkjet textile printing.

[Input Section]

The input section 6 is a member for a user to input information relating to textile printing. Examples of the input section 6 include an operation button and a touch panel. At least information on whether or not the textile printing target T is made of the specific material is input to the input section 6.

[Storage]

The storage 7 stores data therein. The storage 7 is constituted by a storage device and semiconductor memory. Examples of the storage device include a hard disk drive (HDD) and a solid state drive (SSD). Examples of the semiconductor memory include random-access memory (RAM) and read-only memory (ROM). The storage 7 stores a control program therein. The control program contains data for a suitable scanning speed of the carriage 1 when the textile printing target T is made of the specific material and data for a suitable scanning speed of the carriage 1 when the textile printing target T is made of a material other than the specific material.

FIG. 3 is a block diagram for controlling the main elements of the ink jet textile printing illustrated in FIG. 1. As illustrated in FIG. 3, the controller 5 is connected to the carriage 1, the pretreatment head 3, the recording heads 4, the input section 6, and the storage 7. As illustrated in FIG. 3, the controller 5 includes a determination section 5a. The determination section 5a is a processor that executes the control program stored in the storage 7.

Upon receiving input of information relating to textile printing (particularly, information on whether or not the textile printing target T is made of the specific material), the input section 6 transmits the information to the controller 5. The controller 5 acquires the information transmitted from the input section 6. The controller 5 determines a scanning speed of the carriage 1 according to the information. In detail, the controller 5 controls the scanning speed of the carriage 1 so that a scanning speed when information indicating that the material of the textile printing target T is made of the specific material is acquired is higher than a scanning speed when information indicating that the material of the textile printing target T is made of a material other than the specific material is acquired. In the manner described above, the controller 5 performs control so that the time interval X when the material of the textile printing target T is made of the specific material is shorter than the time interval X when the material of the textile printing target T is made of a material other than the specific material.

As descried above, when the textile printing target T is made of the specific material, images with excellent color formability can be formed on the specific material while occurrence of blotting is inhibited through shortening of the time interval X between pretreatment liquid ejection and ink ejection.

The inkjet textile printing apparatus of which main elements are illustrated in FIG. 1 can form images with excellent color formability while inhibiting occurrence of blotting even in a case in which the textile printing target T is made of the specific material and in a case in which the textile printing target T is made of a material other than the specific material through the controller 5 adjusting the scanning speed of the carriage 1 in a manner described above.

An example of the inkjet textile printing apparatus of the present disclosure has been described so far with reference to the accompanying drawings. However, the inkjet textile printing apparatus of the present disclosure is not limited to the inkjet textile printing apparatus of which main elements are illustrated in FIG. 1.

In detail, the inkjet textile printing apparatus of which main elements are illustrated in FIG. 1 is a serial-type inkjet textile printing apparatus. However, the inkjet textile printing apparatus of the present disclosure may be a line-type inkjet textile printing apparatus. In a case in which the inkjet textile printing apparatus of the present disclosure is of line type, the inkjet textile printing apparatus of the present disclosure can control the time interval X by a controller controlling the conveyance speed of a textile printing target.

Furthermore, the inkjet textile printing apparatus of which main elements are illustrated in FIG. 1 includes one pretreatment head 3 and four recording heads 4. However, the number of the pretreatment heads included in the inkjet textile printing apparatus of the present disclosure may be two or more. Also, the number of the recording heads included in the inkjet textile printing apparatus of the present disclosure may be one to three or five or more. For example, the inkjet textile printing apparatus of the present disclosure may include two pretreatment heads, at least one recording heads, and a carriage that accommodates the pretreatment heads and the recording head. In this case, the carriage accommodates one of the pretreatment heads, the at least one recording head, and the other pretreatment head in the stated order in the scanning direction. Of the two pretreatment heads, one pretreatment head ejects the pretreatment liquid in the forward path of the reciprocating motion of the carriage and the other pretreatment head ejects the pretreatment liquid in the return path thereof. The inkjet textile printing apparatus of the present disclosure adopting such a configuration can perform pretreatment and image formation in both the forward path and the return path of the reciprocating motion of the carriage.

Furthermore, the pretreatment head 3 and the recording heads 4 are accommodated in the carriage 1 in the inkjet textile printing apparatus of which main elements are illustrated in FIG. 1. However, the inkjet textile printing apparatus of the present disclosure may have a configuration without a carriage so that the pretreatment head and the recording heads are independent of each other. Furthermore, the input section and the storage are optional elements in the inkjet textile printing apparatus of the present disclosure. In addition, the inkjet textile printing apparatus of the present disclosure may further include any other member (e.g., a heating section that heats a textile printing target after image formation). The following describes preferable examples of the ink and the pretreatment liquid used in the inkjet textile printing apparatus of the present disclosure.

[Ink]

The ink preferably contains a pigment and an anionic dispersant. Preferably, the ink further contains at least one of water, a water-soluble organic solvent, and a nonionic surfactant.

(Pigment)

The pigment is dispersed in a solvent, for example. In terms of improving color density, hue, or stability of the ink, the pigment has a D₅₀ of preferably at least 30 nm and no greater than 250 nm, and more preferably at least 70 nm and no greater than 160 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, more specifically Examples of the violet pigments include C.I. Pigment Violet (19, 23, or 33). Examples of the black pigments include C.I. Pigment Black (7). The pigment has a percentage content in the ink of preferably at least 1.0% by mass and no greater than 12.0% by mass, and more preferably at least 3.0% by mass and no greater than 7.0% by mass. As a result of the percentage content of the pigment being set to at least 1.0% by mass, formed images can have increased image density. As a result of the percentage content of the pigment being set to no greater than 12.0% by mass, fluidity of the ink can be increased.

(Anionic Dispersant)

Examples of the anionic dispersant include anionic surfactants, polycarboxylic acids, and salts of polycarboxylic acids. Examples of the salts of polycarboxylic acids include polycarboxylic acid ammonium salts, polycarboxylic acid amine salts, and polycarboxylic acid metal salts (e.g., polycarboxylic acid sodium salt). The anionic dispersant is preferably a polycarboxylic acid amine salt.

Examples of the anionic surfactants include fatty acid soaps (e.g., sodium stearate and sodium dodecanoate) and sulfonate compounds (e.g., sodium dodecyl sulfate and sodium dodecylbenzenesulfonate).

Examples of the polycarboxylic acids include polyacrylic acids, polymethacrylic acids, polymaleic acids, polyphthalic acids, and copolymers of (meth)acrylic acid and maleic acid. Examples of the amines contained in the polycarboxylic acid amine salts include primary alkyl amine, secondary alkyl amine, and tertiary alkyl amine. Examples of the alkyl groups of the primary alkyl amine, the secondary alkyl amine, and the tertiary alkyl amine include alkyl groups (e.g., a methyl group and an ethyl group) with a carbon number of at least 1 and no greater than 4.

The anionic dispersant has a percentage content in the ink of preferably at least by mass and no greater than 7.0% by mass, and more preferably at least 1.5% by mass and no greater than 3.5% by mass. As a result of the percentage content of the anionic dispersant being set to at least 0.5% by mass, dispersibility of the pigment in the ink can be increased. As a result of the percentage content ratio of the anionic dispersant being set to no greater than 7.0% by mass, ejection stability of the ink can be improved.

(Water) The water has a percentage content in the ink of preferably at least 50.0% by mass and no greater than 90.0% by mass, and more preferably at least 60.0% by mass and no greater than 80.0% by mass.

(Water-soluble Organic Solvent)

Examples of the water-soluble organic solvent include glycol compounds, ether compounds of polyhydric alcohols, lactam compounds, nitrogen-containing compounds, acetate compounds, thiodiglycol, glycerin, and dimethyl sulfoxide.

Examples of the glycol compounds include ethylene glycol, propylene glycol, diethylene glycol, triethylene glycol, and tetraethylene glycol.

Examples of the ether compounds of polyhydric alcohols include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, and propylene glycol monomethyl ether.

Examples of the lactam compounds include 2-pyrrolidone and N-methyl-2-pyrrolidone. Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent is preferably a glycol compound, and more preferably diethylene glycol.

When the ink contains a water-soluble organic solvent, the water-soluble organic solvent has a percentage content in the ink of preferably at least 5.0% by mass and no greater than 50.0% by mass, and more preferably at least 15.0% by mass and no greater than 30.0% by mass.

(Nonionic Surfactant)

The nonionic surfactant improves compatibility and dispersion stability of each component contained in the ink. Furthermore, the nonionic surfactant increases permeability (wettability) of the ink to the textile printing target.

Examples of the nonionic surfactant include polyoxyethylene dodecyl ether, polyoxyethylene hexadecyl ether, polyoxyethylene nonylphenyl ether, polyoxyethylene sorbitan monooleate either, monodecanoyl sucrose, and ethylene oxide adducts of acetylene glycol. The nonionic surfactant is preferably an ethylene oxide adduct of acetylene glycol.

When the ink contains a nonionic surfactant, the nonionic surfactant has a percentage content in the ink of preferably at least 0.1% by mass and no greater than 5.0% by mass, and more preferably at least 0.5% by mass and no greater than 2.0% by mass.

(Other Components)

The ink may further contain any known additives (specific examples include a solution stabilizer, an anti-drying agent, an antioxidant, a viscosity modifier, a pH adjuster, and an antifungal agent) as necessary.

[Ink Preparation Method]

The ink can be prepared for example by uniformly mixing a pigment dispersion, water, and any other components (e.g., the water-soluble organic solvent and the nonionic surfactant) added as necessary using a stirrer. The pigment dispersion contains the pigment and the anionic dispersant. In ink preparation, uniform mixing of each component may be followed by removal of foreign matter and coarse particles by centrifugation. Centrifugation can be carried out for example under conditions of a centrifugal speed of at least 5000 rpm and no greater than 20,000 rpm and a centrifugation time of at least 30 seconds and no greater than 5 minutes.

(Pigment Dispersion)

The pigment dispersion is a dispersion containing the pigment and the anionic dispersant. The dispersion medium of the pigment dispersion is preferably water. Preferably, the pigment dispersion further contains a water-soluble organic solvent.

The pigment has a percentage content in the pigment dispersion of at least 5.0% by mass and no greater than 25.0% by mass, for example. The anionic dispersant has a percentage content in the pigment dispersion of at least 2.0% by mass and no greater than by mass, for example. When the pigment dispersion contains a water-soluble organic solvent, the water-soluble organic solvent has a percentage content in the pigment dispersion of at least 2.0% by mass and no greater than 10.0% by mass, for example.

The pigment dispersion can be prepared by wet dispersion of the pigment, the anionic dispersant, a dispersion medium (e.g., water), and any other component (e.g., the water-soluble organic solvent) added as necessary using a media type wet disperser. In wet dispersion using a media type wet disperser, small-diameter beads (e.g., beads with a D₅₀ of at least 0.5 mm and no greater than 1.5 mm) can be used as a medium, for example. The material of the beads is not particularly limited, but is preferably a hard material (e.g., glass or zirconia).

When the pigment dispersion is used in ink preparation, the proportion of the pigment dispersion to all raw materials of the ink is at least 25.0% by mass and no greater than 60.0% by mass, for example.

[Pretreatment Liquid]

The pretreatment liquid is preferably a resin emulsion containing binder resin particles. The binder resin particles contain a binder resin. Preferably, the resin emulsion is a forced-emulsifying resin emulsion further containing a cationic surfactant or a self-emulsifying resin emulsion in which the binder resin is cationic. Preferably, the pretreatment liquid further contains at least one of water, a water-soluble organic solvent, and a nonionic surfactant.

Here, the self-emulsifying resin emulsion and the forced-emulsifying resin emulsion are described. The self-emulsifying resin emulsion contains binder resin particles. The binder resin particles contained in the self-emulsifying resin emulsion are dispersible in water even in a state in which an emulsifier, a dispersant, and a surfactant are not present. Typically, the binder resin particles contained in the self-emulsifying resin emulsion contain a binder resin having a hydrophilic group (e.g., a cationic group). The forced-emulsifying resin emulsion contains binder resin particles and at least one of a emulsifier, a dispersant, and a surfactant. The binder resin particles contained in the forced-emulsifying resin emulsion are non-dispersible in water in a state in which an emulsifier, a dispersant, and a surfactant are not present. Typically, the binder resin particles contained in the forced-emulsifying resin emulsion contain a binder resin with relatively high hydrophobicity.

The resin emulsion is preferably a forced-emulsifying resin emulsion further containing a cationic surfactant. Typically, the binder resin contained in the forced-emulsifying resin emulsion includes a binder resin with relatively high hydrophobicity. Therefore, when the resin emulsion is a forced-emulsifying resin emulsion, relatively high hydrophobicity can be imparted to the surfaces of formed images. As a result, color fastness to rubbing (particularly, color fastness to wet rubbing) of formed images can be increased.

(Binder Resin Particles)

The binder resin particles contain a binder resin. The binder resin has a percentage content in the binder resin particles of preferably at least 80% by mass, more preferably at least 95% by mass, and further preferably 100% by mass.

The binder resin particles have a D50 of preferably at least 30 nm and no greater than 500 nm, more preferably at least 100 nm and no greater than 400 nm, and further preferably at least 150 nm and no greater than 350 nm. As a result of the D50 of the binder resin particles being set to at least 30 nm and no greater than 500 nm, occurrence of nozzle clogging can be inhibited in ejection of the pretreatment liquid.

The binder resin particles have a percentage content in the pretreatment liquid of preferably at least 1.0% by mass and no greater than 15.0% by mass, and more preferably at least 3.0% by mass and no greater than 10.0% by mass. As a result of the percentage content of the binder resin particles being set to at least 1.0% by mass, occurrence of blotting can be further effectively inhibited and color formability of formed images can be further improved. As a result of the percentage content of the binder resin particles being set to no greater than 15.0% by mass, occurrence of nozzle closing can be inhibited in ejection of the pretreatment liquid from nozzles.

(Binder Resin)

Examples of the binder resin include (meth)acrylic resin, styrene resin, polyvinyl resin, polyester resin, amino resin, epoxy resin, urethane resin, polyether resin, polyamide resin, phenolic resin, silicone resin, fluororesin, and copolymers (e.g., styrene-(meth)acrylic resin) including monomers of any of these resins. The binder resin is preferably polyester resin, styrene-(meth)acrylic resin, or urethane resin.

(Polyester Resin)

When the resin emulsion is a forced-emulsifying resin emulsion, the polyester resin preferably does not have a cationic group. When the resin emulsion is a self-emulsifying resin emulsion, the polyester resin preferably has a cationic group. An example of the cationic group is a cationic quaternary ammonium group.

The polyester resin is obtained by condensation polymerization of one or more polyhydric alcohols and one or more polybasic carboxylic acids. Examples of polyhydric alcohols for synthesis of the polyester resin include dihydric alcohols (e.g., diol compounds and bisphenols) and tri or more-hydric alcohols. Examples of polybasic carboxylic acids for synthesis of the polyester resin include dibasic carboxylic acids and tri- or more-basic carboxylic acids. Note that in synthesis of the polyester resin, a polybasic carboxylic acid derivative (e.g., a polybasic carboxylic acid anhydride or a polybasic carboxylic acid halide) that can form an ester bond through condensation polymerization may be used instead of a polybasic carboxylic acid.

Examples of diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenols include bisphenol A, hydrogenated bisphenol A, bisphenol A-ethylene oxide adducts, and bisphenol A propylene oxide adducts.

Examples of the tri or more-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkylsuccinic acids (e.g., n-butylsuccinic acid, isobutylsuccinic acid, n-octylsuccinic acid, n-dodecylsuccinic acid, and isododecylsuccinic acid), and alkenylsuccinic acids (e.g., n-butenylsuccinic acid, isobutenylsuccinic acid, n-octenylsuccinic acid, n-dodecenylsuccinic acid, and isododecenylsuccinic acid).

Examples of the tri- or more-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylene carboxy)methane, 1,2,7,8-octanetetracarboxylic acid, pyromellitic acid, and Empor trimeric acid.

In synthesis of a polyester resin having a cationic group, a polyhydric alcohol, a polybasic carboxylic acid, and a compound having a cationic group are preferably used as raw materials of the polyester resin. An example of the compound having a cationic group is a compound (also referred to below as cationic compound (A)) having a cationic group and at least one of a hydroxy group and a carboxy group. The cationic compound (A) provides the polyester resin with a cationic end group or a repeating unit having a cationic group.

Examples of the cationic compound (A) include carnitine, acetyl carnitine, N,N,N-trimethylglycine(glycine betaine), N,N,N-triethylglycine, N,N,N-tripropylglycine, N,N,N-triisopropylglycine, N,N,N-trimethyl-y-aminobutyric acid, N,N,N-trimethylalanine, N,N,N-triethylalanine, N,N,N-triisopropylalanine, N,N,N-trimethyl-2-methylalanine, N,N,N-trimethylammoniopropionate, and prolinebetaine. The cationic compound (A) may be a salt compound (e.g., hydrochloride). An example of a cationic compound (A) being a salt compound is betaine hydrochloride (hydrochloride salt of glycine betaine). The cationic compound (A) is preferably betaine hydrochloride.

When the raw materials of the polyester resin include a cationic compound (A), the cationic compound (A) has a percentage content in the raw materials of the polyester resin of preferably at least 0.1% by mass and no greater than 10.0% by mass, and more preferably at least 1.0% by mass and no greater than 3.0% by mass.

When the polyester resin does not have a cationic group, the raw materials of the polyester resin preferably include terephthalic acid, ethylene glycol, 1,6-hexanediol, and a benzoic anhydride.

When the polyester resin has a cationic group, the raw materials of the polyester resin preferably include terephthalic acid, betaine hydrochloride, ethylene glycol, 1,6-hexanediol, and a benzoic acid or a benzoic anhydride.

(Styrene-(Meth)Acrylic Resin)

The styrene-(meth)acrylic resin is a resin including a unit derived from styrene and a unit derived from (meth)acrylic acid or (meth)acrylic acid ester.

Examples of the (meth)acrylic acid ester include (meth)acrylic acid alkyl esters. Examples of the (meth)acrylic acid alkyl esters include methyl (meth)acrylate, ethyl (meth)acrylate, butyl (meth)acrylate, 2-ethylhexyl (meth)acrylate, and lauryl (meth)acrylate.

A preferable styrene-acrylic resin is a copolymer of styrene, butyl acrylate, lauryl acrylate, methyl methacrylate, and 2-ethylhexyl acrylate.

(Cationic Surfactant)

Examples of the cationic surfactant include amine salt surfactants and quaternary ammonium salt surfactants. Example of the amine salt surfactants include alkylamine acetates (e.g., stearylamine acetate) having an alkyl group with a carbon number of at least 10 and no greater than 25. Examples of the quaternary ammonium salt surfactants include alkyl trimethyl ammonium salts (e.g., cetyltrimethylammonium chloride) having an alkyl group with a carbon number of at least 10 and no greater than 25. The cationic surfactant is preferably a quaternary ammonium salt surfactant, and more preferably cetyltrimethylammonium chloride.

When the pretreatment liquid contains a cationic surfactant, the cationic surfactant has a percentage content in the pretreatment liquid of preferably at least 0.1% by mass and no greater than 3.0% by mass, and more preferably at least 0.3% by mass and no greater than 1.0% by mass. As a result of the percentage content of the cationic surfactant being set to at least 0.1% by mass, dispersibility of the binder resin particles can be increased. As a result of the percentage content of the cationic surfactant being set to no greater than 3.0% by mass, color fastness to rubbing of formed images can be increased.

(Water) The water has a percentage content in the pretreatment liquid of preferably at least by mass and no greater than 90.0% by mass, and more preferably at least 60.0% by mass and no greater than 80.0% by mass.

(Water-soluble Organic Solvent)

Examples of the water-soluble organic solvent include the same water-soluble organic solvents as those listed in the description of the ink. The water-soluble organic solvent is preferably a glycol compound, and more preferably diethylene glycol.

When the pretreatment liquid contains a water-soluble organic solvent, the water-soluble organic solvent has a percentage content in the pretreatment liquid of preferably at least 5.0% by mass and no greater than 50.0% by mass, and more preferably at least by mass and no greater than 40.0% by mass.

(Nonionic Surfactant)

The nonionic surfactant adjusts surface tension of the pretreatment liquid. Examples of the nonionic surfactant include the same nonionic surfactants as those listed in the description of the ink. The nonionic surfactant is preferably an ethylene oxide adduct of acetylene glycol.

When the pretreatment liquid contains a nonionic surfactant, the nonionic surfactant has a percentage content in the pretreatment liquid of preferably at least 0.1% by mass and no greater than 5.0% by mass, and more preferably at least 0.5% by mass and no greater than 2.0% by mass. As a result of the percentage content of the nonionic surfactant being set to at least 0.1% by mass and no greater than 5.0% by mass, ejection stability of the pretreatment liquid can be improved.

[Pretreatment Liquid Preparation Method]

The pretreatment liquid can be prepared for example by uniformly mixing using a stirrer a raw material emulsion containing the binder resin particles to which any other components (e.g., water, the water-soluble organic solvent, and the nonionic surfactant) have been added as necessary. Preferably, the raw material emulsion is a forced-emulsifying resin emulsion further containing a cationic surfactant or a self-emulsifying resin emulsion in which the binder resin is cationic.

(Raw Material Emulsion)

Water may be used as a dispersion medium of the raw material emulsion, for example. A raw material emulsion being a self-emulsifying resin emulsion can be prepared by stirring a mixture containing the binder resin and a dispersion medium under pressure heating. The binder resins has a percentage content in the mixture of at least by mass and no greater than 45.0% by mass, for example. A raw emulsion being a forced-emulsifying resin emulsion can be prepared by stirring a mixture containing the binder resin, a dispersion medium, and a cationic surfactant under pressure heating. The binder resin has a percentage content in the mixture of at least 15.0% by mass and no greater than 45.0% by mass, for example. The cationic surfactant has a percentage content in the mixture of at least 1.0% by mass and no greater than 6.0% by mass, for example.

The raw material emulsion can be prepared for example under conditions of a treatment temperature of at least 100° C. and no greater than 150° C. and a treatment time of at least 1 hour and no greater than 4 hours.

When the raw material emulsion is used in preparation of the pretreatment liquid, the raw material emulsion has a percentage content in all the raw materials of the pretreatment liquid of at least 10.0% by mass and no greater than 25.0% by mass, for example.

What is claimed is:

1. An inkjet textile printing apparatus that forms an image on am image formation area of a textile printing target, comprising:
a pretreatment head that ejects a pretreatment liquid toward the image formation area;
a recording head that ejects an inkjet ink toward the image formation area; and
a controller that controls a time interval X from ejection of the pretreatment liquid toward the image formation area by the pretreatment head to ejection of the inkjet ink toward the image formation area by the recording head, wherein
the controller performs control so that the time interval X when the textile printing target is made of a specific material is shorter than the time interval X when the textile printing target is made of a material other than the specific material, and
the specific material is a napped material, a wool material, or an animal hair material.

2. The inkjet textile printing apparatus according to claim 1, wherein
the inkjet textile printing apparatus is of serial type,
the inkjet textile printing apparatus further comprises a carriage that accommodates the pretreatment head and the recording head, and
the controller controls the time interval X by controlling a scanning speed of the carriage.

3. The inkjet textile printing apparatus according to claim 1, further comprising
an input section that receives input of information on whether or not the textile printing target is made of the specific material, wherein
the controller acquires the information input to the input section.

4. The inkjet textile printing apparatus according to claim 1, wherein
the inkjet ink contains a pigment and an anionic dispersant,
the pretreatment liquid is a resin emulsion containing binder resin particles,
the binder resin particles contain a binder resin, and
the resin emulsion is
a forced-emulsifying resin emulsion further containing a cationic surfactant, or
a self-emulsifying resin emulsion in which the binder resin is cationic.
